(19) United States
(12) Patent Application Publication
(10) Pub. No.: US 2026/0273410 A1
(43) Pub. Date: Sep. 17, 2026

(54) ONE OR MORE NON-TRANSITORY COMPUTER-READABLE STORAGE MEDIA HAVING STORED THEREIN A PROGRAM CAUSING A COMPUTER TO PERFORM INFORMATION PROCESSING WHEN EXECUTED BY ONE OR MORE PROCESSORS, AN INFORMATION PROCESSING SYSTEM, COMPUTER IMPLEMENTED METHOD

(71) Applicant: NINTENDO CO., LTD., Kyoto (JP)

(72) Inventors: Ryan C. CORNELIUS, Austin, TX (US); Benjamin D. JOHNSON, Austin, TX (US)

(21) Appl. No.: 19/327,190

(22) Filed: Sep. 12, 2025

Related U.S. Application Data
(63) Continuation-in-part of application No. 19/081,643, filed on Mar. 17, 2025.

(51) Int. Cl. A63F 13/56; A63F 13/211; A63F 13/98

(52) U.S. Cl. CPC A63F 13/56; A63F 13/211; A63F 13/98

(57) ABSTRACT

Information processing operates a first virtual object in a first mode, based on output of a first mouse sensor provided in a first controller, and operates a first virtual object in a second mode, based on output of a first sensor provided in the first controller. The first controller is configured to be detachably attached to a peripheral device that covers an opening to the first mouse sensor. The information processing includes changing from the second mode to the first mode, based on the opening being covered. The information processing includes changing from the first mode to the second mode, based on the opening to the first mouse sensor being covered, movement in two-dimensional directions indicated by the first mouse sensor being smaller than a first value, and movement of the first controller indicated by an inertial sensor provided in the first controller being greater than a second value.

### CROSS REFERENCE TO RELATED APPLICATIONS

This application is a continuation-in part of U.S. patent application Ser. No. 19/081,643 filed Mar. 17, 2025, the entire contents of which are hereby incorporated by reference.

### FIELD

The present disclosure relates to information processing based on an operation to a controller.

### BACKGROUND AND SUMMARY

Conventionally, there has been known a controller having a mouse sensor. A virtual object is operated based on an output of the mouse sensor. The controller may have input means other than the mouse sensor. The present disclosure provides a favorable user experience in a case of operating an object by a mouse sensor or other input means.

(1) An example of a non-transitory computer-readable storage medium according to the present disclosure has stored therein a program causing a computer to perform information processing. The information processing includes: in a first mode, operating a first virtual object based on output from a first mouse sensor of a first controller configured to be detachably attached to a peripheral device that covers an opening to the first mouse sensor; in a second mode, operating the first virtual object or a second virtual object based on output from a first sensor of the first controller, without operating the first virtual object based on output from the first mouse sensor; changing from the second mode to the first mode based at least on the opening to the first mouse sensor of the first controller being covered; and changing from the first mode to the second mode based at least on the opening to the first mouse sensor being covered, movement in two-dimensional directions indicated by the first mouse sensor being smaller than a first value, and movement of the first controller indicated by a first inertial sensor of the first controller being greater than a second value.

(2) In the configuration described above in (1), changing from the first mode to the second mode based at least on the opening to the first mouse sensor not being covered.

(3) In the configuration described above in (1), the information processing comprises: in a third mode, operating the first virtual object or the second virtual object in a manner different from the second mode, based on output from the first sensor, without operating the first virtual object based on output from the first mouse sensor; and changing from the first mode to the third mode based at least on the opening to the first mouse sensor not being covered.

(4) In the configuration described above in (1), wherein the information processing comprises: changing from the first mode to the second mode based at least on: the opening to the first mouse sensor being covered, movement in two-dimensional directions indicated by the first mouse sensor being smaller than a first value, movement of the first controller indicated by a first inertial sensor being greater than a second value, the opening to a second mouse sensor of a second controller configured to be detachably attached to the peripheral device being covered, movement in two-dimensional directions indicated by the second mouse sensor being smaller than a third value, and movement of the second controller indicated by a second inertial sensor of the second game controller being greater than a fourth value.

(5) In the configuration described above in (1), wherein the first sensor is at least one of: the first inertial sensor, or a sensor configured to detect operation on a first directional input unit of the controller.

The configurations (1) to (5) above are merely examples. These and other features, aspects, and effects will become more apparent from the following detailed description when taken in conjunction with the accompanying drawings.

### BRIEF DESCRIPTION OF THE DRAWINGS

FIG. 1 shows a non-limiting example of a state in which a left controller and a right controller are attached to a main body apparatus;

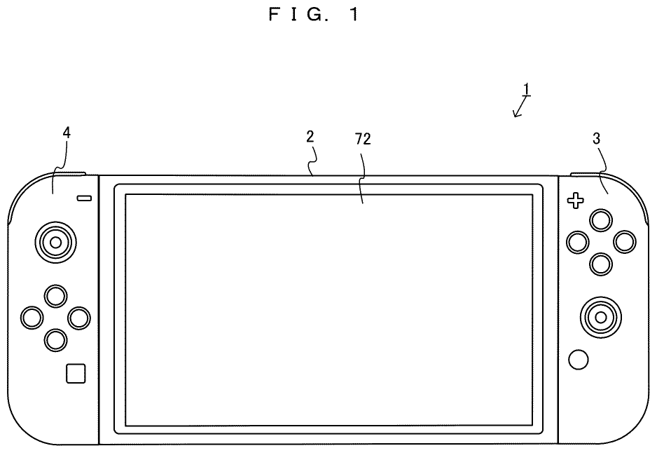

FIG. 2 is six orthogonal views showing a non-limiting example of the left controller;

FIG. 3 is six orthogonal views showing a non-limiting example of the right controller;

FIG. 4 is a block diagram showing a non-limiting example of the internal configuration of the main body apparatus;

FIG. 5 is a block diagram showing a non-limiting example of the internal configurations of the main body apparatus, the left controller, and the right controller;

FIG. 6 shows a non-limiting example of a state in which the right controller is operated while being grasped by a right hand;

FIG. 7 shows a non-limiting example of a state in which the right controller is operated while being grasped by a right hand;

FIG. 8 shows a non-limiting example of a state in which the right controller is operated while being grasped by both hands;

FIG. 9 illustrates a non-limiting example of shift of an operation mode of a controller;

FIG. 10 shows a non-limiting example of various data to be used in information processing in a game system;

FIG. 11 shows a non-limiting example of a flowchart of the information processing;

FIG. 12 shows a non-limiting example of a flowchart of the information processing.

FIG. 13 shows is six orthogonal views showing a non-limiting example of the peripheral device:

FIG. 14 shows is six orthogonal views showing a non-limiting example of the peripheral device with the controllers attached;

FIG. 15 shows a non-limiting example of a flowchart of the information processing; and

FIG. 16 shows a non-limiting example of a flowchart of the information processing.

### DETAILED DESCRIPTION OF NON-LIMITING EXAMPLE EMBODIMENTS

Hereinafter, an exemplary embodiment will be described. In the following description, a term with “a” or “an” at the head thereof is not necessarily intended to be a singular form and should be understood as not excluding a plural form.

### Example of Hardware Configuration of Information Processing System

Hereinafter, a game system which is an example of an information processing system will be described. A game system 1 in the exemplary embodiment includes a main body apparatus 2, a left controller 4, and a right controller 3. The main body apparatus 2 is an example of an information processing apparatus. The information processing apparatus may be a personal computer, a tablet terminal, a smartphone, a wearable terminal, a server, or the like, for example. The left and right controllers 3 and 4 are examples of a controller. The controller may be a general-purpose mouse, for example. The controller is also an example of the information processing apparatus. The information processing apparatus and the controller are examples of a computer. The wording “computer” does not necessarily mean one device, and can mean an entirety of a plurality of devices connected via a wire or wirelessly. Each of such information processing apparatuses and controllers can be an example of the information processing system.

The main body apparatus 2 is an apparatus for executing various kinds of processing (e.g., game processing) in the game system 1. The main body apparatus 2 includes a display 72.

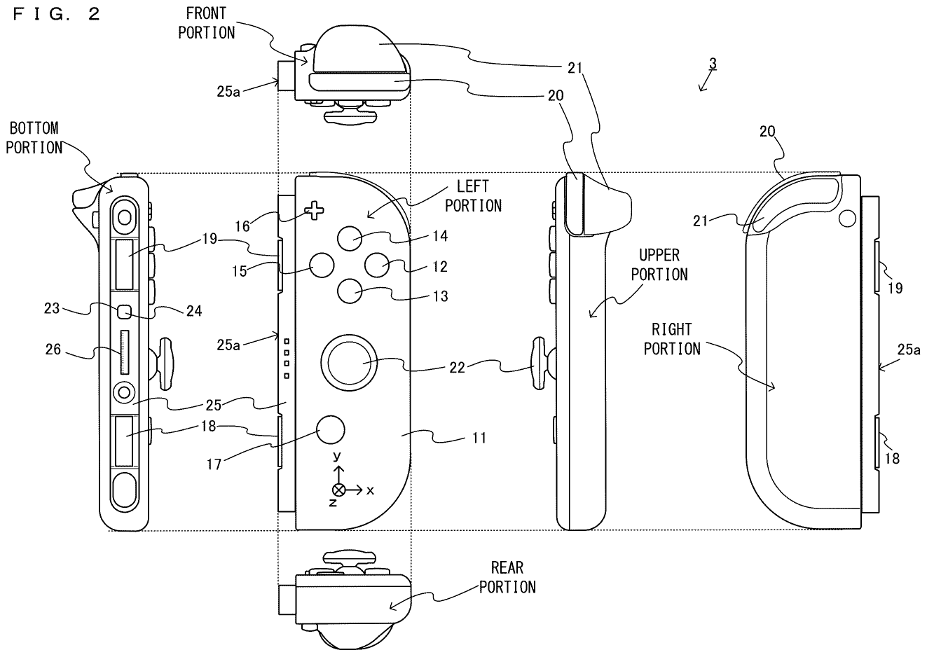

The left controller 4 and the right controller 3 have operation portions and the like on which a user performs input. Hereinafter, the left controller 4 and the right controller 3 may be collectively referred to as “controllers”. FIG. 2 is six orthogonal views schematically showing an example of the right controller 3. As shown in FIG. 2, the right controller 3 has a vertically long plate shape, has a housing 11, and has a front portion, a rear portion, an upper portion, a bottom portion, a right portion, and a left portion. As described later, an opening for mouse sensor is provided at the bottom portion. Regarding the right controller 3, the rear portion is located on a side opposite to the front portion, the bottom portion is located on a side opposite to the upper portion, and the left portion is located on a side opposite to the right portion. The distance between the front portion and the rear portion is greater than the distance between the upper portion and the bottom portion. The distance between the upper portion and the bottom portion is greater than the distance between the right portion and the left portion. In another exemplary embodiment, these distances may have another magnitude relationship. In the exemplary embodiment, a direction connecting the bottom portion and the upper portion is referred to as an up-down direction, a direction perpendicular to the up-down direction and connecting the front portion and the rear portion is referred to as a front-rear direction, and a direction perpendicular to the up-down direction and connecting the right portion and the left portion is referred to as a left-right direction. In FIG. 2, x, y, and z axes are shown on a plan view in which the left portion faces the near side, and represent a coordinate system of the right controller 3. In this coordinate system, a direction heading toward the right portion from the left portion is a z-axis plus direction. A direction perpendicular to the z axis and heading toward the upper portion from the bottom portion is an x-axis plus direction. A direction perpendicular to the z axis and the x axis and heading toward the front portion from the rear portion is a y-axis plus direction. When the bottom portion is directed in the gravity direction, an x-axis minus direction and the gravity direction coincide with each other. In the exemplary embodiment, portions such as the front portion and the bottom portion need not be perfectly flat, and may have a recess, a projection, and/or a slope. For example, the bottom portion includes a protruding portion 25 described later. A direction in which each portion faces and a direction connecting the portions are merely directions schematically shown in the drawings.

The right controller 3 has the protruding portion 25 to be fitted into a recessed portion (not shown) of the main body apparatus 2, in a state of being attached to the main body apparatus 2. As shown in FIG. 2, the protruding portion 25 has a protruding shape protruding in the x-axis minus direction and having a left-right width shorter than that of the right controller 3 and a front-rear width shorter than that of the right controller 3. In the exemplary embodiment, the protruding portion 25 is a part of the bottom portion.

As described later, the right controller 3 can be grasped in an orientation in which the right controller 3 is vertically long, in a state of being detached from the main body apparatus 2. The right controller 3 has such a shape and a size that the right controller 3 can be grasped by one hand, in particular, a right hand, in a case of being grasped in the orientation in which the right controller 3 is vertically long. The right controller 3 can also be grasped in an orientation in which the right controller 3 is horizontally long, and may be grasped by both hands in a case of being grasped in the orientation in which the right controller 3 is horizontally long.

The right controller 3 has, at the left portion, an analog stick (which may be simply referred to as a “stick”) 22 which is an example of a directional input portion. The stick 22 can be used as a directional input portion via which a direction can be inputted. The user can perform directional input corresponding to a tilt direction by tilting the stick 22 in a desired direction in a range of 360 degrees, and can perform input with a magnitude corresponding to the tilt angle. In addition, the user can perform button input by pushing the stick 22 in. The stick may be slidable, instead of being tiltable. The directional input portion may be a directional pad, for example.

The right controller 3 has, at the left portion, a set of four buttons which are an A button 12, a B button 13, an X button 14, and a Y button 15, a +(plus) button 16, and a home button 17. The right controller 3 has an R button 20 and a ZR button 21 over a range from the front portion to the upper portion. The R button 20 and the ZR button 21 may be provided at only the front portion of the right controller 3, or may be provided only at the upper portion of the right controller 3. The right controller 3 has a button 18 and a button 19 at a top surface 25a of the protruding portion 25. The right controller 3 has no operation portion at the rear portion.

The right controller 3 has an opening 23 for mouse sensor, at the top surface 25a of the protruding portion 25. The opening 23 for mouse sensor is an opening of a light guide path for guiding light to a mouse sensor 24 provided inside the right controller 3. The mouse sensor 24 is an optical-type mouse sensor and has at least a light receiving portion. Light to be detected by the light receiving portion may be visible light or light having an invisible wavelength. The mouse sensor 24 may have a light emitting portion. Light from the light emitting portion may be emitted through the opening 23 to the outside. The mouse sensor 24 acquires data that enables calculation of movement or the like on a placement surface, of the right controller 3 placed such that the top surface 25a of the protruding portion 25 of the bottom portion faces the placement surface. Thus, the right controller 3 can be used also as a mouse.

In the exemplary embodiment, the direction in which the bottom portion extends when the right controller 3 is placed on the placement surface with the top surface 25a facing the placement surface is parallel to the direction in which the placement surface extends.

In the exemplary embodiment, the right controller 3 has, at the protruding portion 25, a terminal 26 for the right controller 3 to perform wired communication with the main body apparatus 2. The terminal 26 is provided on an inner peripheral surface of a recess formed in the top surface 25a of the protruding portion 25, for example.

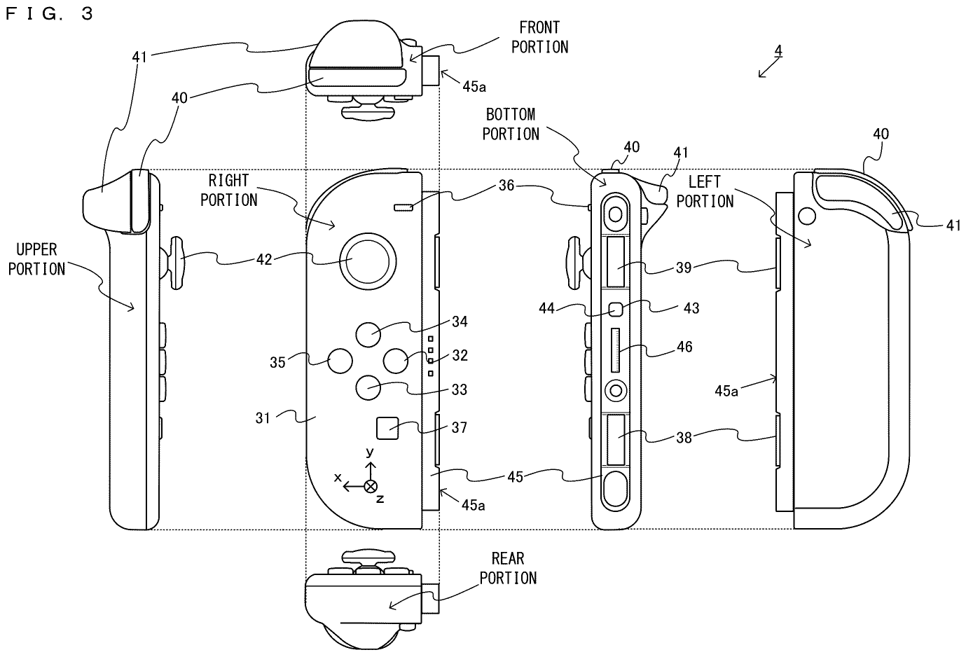

FIG. 3 is six orthogonal views schematically showing an example of the left controller 4. Description of similar configurations as those of the right controller 3 is omitted. The left controller 4 has, at a right portion, a stick 42, a set of four buttons which are a right direction button 32, an up direction button 33, a down direction button 34, and a left direction button 35, a capture button 37, and a-(minus) button 36. The buttons 32 to 35 may be formed by one directional pad. The left controller 4 has an L button 40 and a ZL button 41 over a range from the front portion to the upper portion. The left controller 4 has no operation portion at a rear portion. In the right controller 3, the stick 22 is located rearward of the buttons 12 to 15, whereas in the left controller 4, the stick 42 is located frontward of the buttons 32 to 35. In FIG. 3, x, y, and z axes are shown on a plan view in which the right portion faces the near side, and represent a coordinate system of the left controller 4. In this coordinate system, a direction heading toward the left portion from the right portion is a z-axis plus direction. A direction perpendicular to the z axis and heading toward the upper portion from the bottom portion is an x-axis plus direction. A direction perpendicular to the z axis and the x axis and heading toward the front portion from the rear portion is a y-axis plus direction. When the bottom portion is directed in the gravity direction, an x-axis minus direction and the gravity direction coincide with each other.

The left controller 4 has a protruding portion 45 to be fitted into a recessed portion (not shown) of the main body apparatus 2, in a state of being attached to the main body apparatus 2. The protruding portion 45 has buttons 38 and 39, a mouse sensor 44, and a terminal 46, as with the right controller 3.

The left controller 4 can be grasped in an orientation in which the left controller 4 is vertically long or horizontally long, in a state of being detached from the main body apparatus 2, as with the right controller 3.

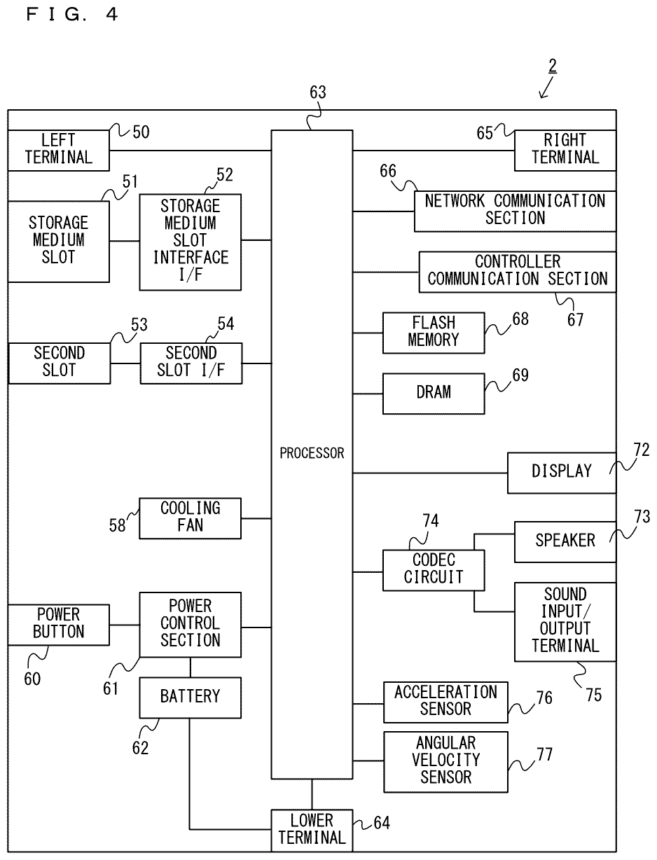

FIG. 4 is a block diagram showing an example of the configuration of the main body apparatus 2. The main body apparatus 2 includes a processor 63. The processor 63 is an information processing section which executes various kinds of information processing to be executed in the main body apparatus 2. The processor 63 may be composed of, for example, a plurality of processors and cores, or typically, a plurality of CPUs (Central Processing Units) and cores, or may be formed by a SoC (System-on-a-chip) including a plurality of functions such as a CPU function, a GPU (Graphics Processing Unit) function, and/or the like. In the exemplary embodiment, the wording “processor” may include at least a CPU (Central Processing Unit), a GPU (Graphics Processing Unit), an ASIC (Application Specific Integrated Circuit), a FPGA (Field Programmable Gate Array), and/or the like. The processor 63 executes various kinds of information processing by executing a program (e.g., a program for executing a game application) stored in a storage section (e.g., an internal storage medium such as a flash memory 68 or an external storage medium attached to a slot 51).

A program for causing the computer to execute each process may be a single program or a program set including a plurality of programs. The wording “program” means not only a single program but also a program set. Programs need not be all stored in one device.

The wording “program” may mean a collection of programs stored in a plurality of devices included in the information processing system, for example.

The main body apparatus 2 includes the flash memory 68, and a DRAM (Dynamic Random Access Memory) 69, as an example of an internal storage medium. The flash memory 68 is a memory that is mainly used for storing various data to be stored in the main body apparatus 2. The DRAM 69 is a memory that is mainly used for temporarily storing various data to be used in information processing. The processor 63 reads and writes data from and into storage mediums such as the flash memory 68 and the DRAM 69 as appropriate, to execute various kinds of information processing. In the exemplary embodiment, the wording “memory” may include at least a flash memory and a DRAM, and may include another storage medium.

The main body apparatus 2 includes various components, as shown in FIG. 4.

Hereinafter, the components will be briefly described. A storage medium slot interface (which may be referred to as “slot I/F”) 52 performs reading/writing of data from/into a storage medium (e.g., a dedicated memory card) attached to the storage medium slot 51, in accordance with an instruction from the processor 63. A second slot I/F 54 performs reading/writing of data from/into a storage medium attached to a second slot 53, in accordance with an instruction from the processor 63.

A network communication section 66 performs communication (e.g., Internet communication using wireless communication) with an external device via a network. A controller communication section 67 performs wireless communication (e.g., communication compliant with the standard of Bluetooth (registered trademark)) with the left controller 4 and/or the right controller 3.

A left terminal 50 is a terminal for performing wired communication between the processor 63 and the left controller 4. A right terminal 65 is a terminal for performing wired communication between the processor 63 and the right controller 3. A lower terminal 64 is a terminal for performing communication with another apparatus (e.g., a stationary monitor) via a cradle when the lower terminal 64 is attached to the cradle, for example.

A codec circuit 74 controls input and output of sound data to and from a speaker 73 and a sound input/output terminal 75.

A power control section 61 controls supply of power from a battery 62 to each section of the main body apparatus 2 (i.e., each of sections to be supplied with power from the battery 62), based on an instruction from the processor 63, and starts or stops supply of power in response to pressing of a power button 60.

The main body apparatus 2 includes various sensors such as an acceleration sensor 76 and an angular velocity sensor 77. The processor 63 can execute various kinds of processing, based on information from these sensors.

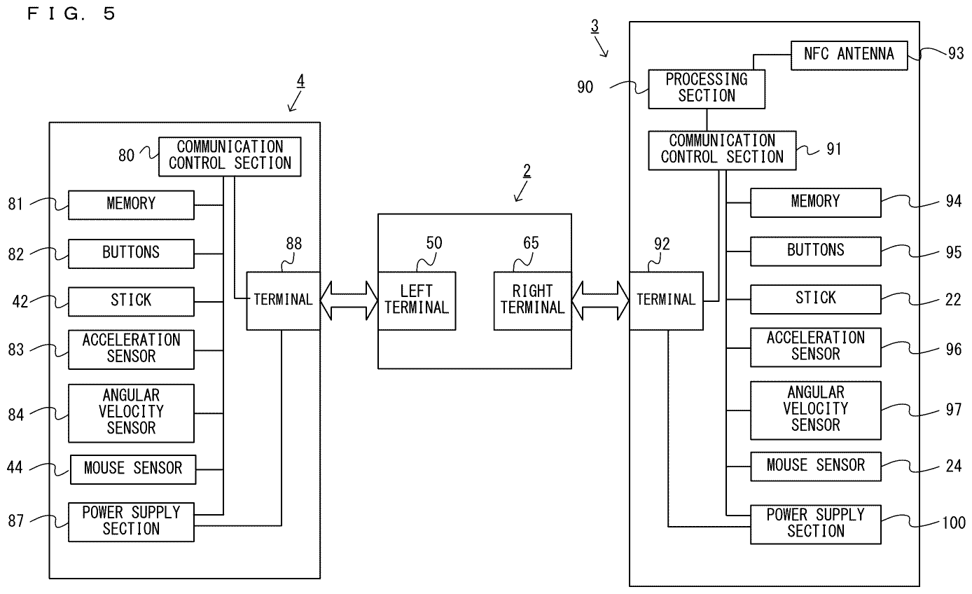

FIG. 5 is a block diagram showing an example of configurations of the main body apparatus 2, the left controller 4, and the right controller 3. The details of the configuration of the main body apparatus 2 have already been shown in FIG. 4 and therefore are not shown in FIG. 5.

The left controller 4 includes a communication control section 80 which performs communication with the main body apparatus 2. As shown in FIG. 5, the communication control section 80 is connected to various components including a terminal 88. In a state in which the left controller 4 is attached to the main body apparatus 2, the communication control section 80 performs wired communication with the main body apparatus 2 via the terminal 88, and in a state in which the left controller 4 is detached from the main body apparatus 2, the communication control section 80 performs wireless communication (e.g., communication compliant with the standard of Bluetooth (registered trademark)) with the main body apparatus 2.

The left controller 4 includes a memory 81 such as a flash memory, for example. The communication control section 80 is formed by a processor such as a microcomputer (or a microprocessor), for example, and executes various kinds of processing by executing firmware stored in the memory 81.

The communication control section 80 acquires information about an operation performed on each button 82 and the stick 42.

The left controller 4 includes an inertial sensor. Specifically, the left controller 4 includes an acceleration sensor 83 and an angular velocity sensor 84. The acceleration sensor 83 and the angular velocity sensor 84 are connected to the communication control section 80.

The communication control section 80 repeatedly acquires detection results from the acceleration sensor 83 and the angular velocity sensor 84 at appropriate timings. The inertial sensor may be one of the acceleration sensor and the angular velocity sensor, or may be another sensor.

The left controller 4 includes the mouse sensor 44. The mouse sensor 44 acquires data for calculating movement or the like of the left controller 4 placed on a placement surface. The communication control section 80 repeatedly acquires the data acquired by the mouse sensor 44, at appropriate timings.

The communication control section 80 transmits left controller data including acquired information or information obtained by performing predetermined processing on the acquired information, to the main body apparatus 2. The left controller data may be repeatedly transmitted at predetermined timings. For example, the communication control section 80 may transmit the left controller data in response to a data request repeatedly received from the main body apparatus 2 at predetermined timings.

The left controller 4 includes a power supply section 87. The power supply section 87 includes a battery and a power control circuit. The power control circuit is connected to the battery, and supplies power to each section of the left controller 4 (specifically, each of sections to be supplied with power from the battery).

As shown in FIG. 5, the right controller 3 has a configuration similar to the left controller 4. For example, the right controller 3 includes a communication control section 91 which is formed by a processor or the like and performs communication with the main body apparatus 2. The right controller 3 includes a memory 94 connected to the communication control section 91. The communication control section 91 is connected to components including a terminal 92. The communication control section 91 and the memory 94 have the same functions as the communication control section 80 and the memory 81 of the left controller 4. Therefore, the communication control section 91 is capable of performing communication with the main body apparatus 2 by both of wired communication via the terminal 92 and wireless communication not via the terminal 92, and controls communication that the right controller 3 performs with the main body apparatus 2. For example, the communication control section 91 acquires information about an operation performed on each button 95 and the stick 22, and transmits the information to the main body apparatus 2.

The right controller 3 includes a processing section 90 and an NFC antenna 93. The processing section 90 controls the NFC antenna 93 in accordance with an instruction from the main body apparatus 2 via the communication control section 91. The NFC antenna 93 performs short-range wireless communication based on the standard of NFC (Near Field Communication).

For at least the right controller 3 and the left controller 4, the main body apparatus 2 may have various data regarding the controllers in advance. For example, the right controller 3 and the left controller 4 are each allocated with controller type information at the time of manufacturing, and the main body apparatus 2 may have various kinds of information together with the controller type information.

### Manner of Grasping Controller

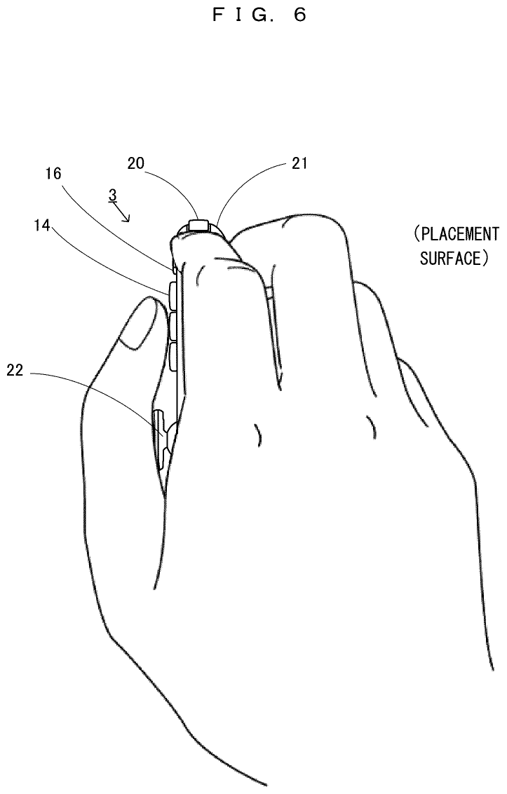

FIG. 6 is a schematic view showing an example of a state in which the user places the right controller 3 on a placement surface and uses the right controller 3 as a mouse with the right hand put thereon. As shown in FIG. 6, the front portion of the right controller 3 faces frontward and the left portion thereof faces leftward. The palm of the right hand of the user covers the upper portion side of the right controller 3. The thumb of the right hand of the user is placed on the left portion side of the right controller 3. The thumb of the right hand of the user is put on the A button 12, for example. The index finger of the right hand of the user is put on the R button 20, for example, and the middle finger of the right hand of the user is put on the ZR button 21, for example. The user can operate the R button 20 and the ZR button 21 by the index finger or the middle finger of the right hand. The user can operate each input portion provided at the left portion, by the thumb of the right hand. Also in a case where the user uses the left controller 4 as a mouse by the left hand, the user can use the left controller 4 on a placement surface with the left hand put thereon in the same manner. At this time, the right portion of the left controller 4 faces rightward. The user may put the left hand on the right controller 3 with the front portion facing frontward, or may put the right hand on the left controller 4 with the front portion facing frontward.

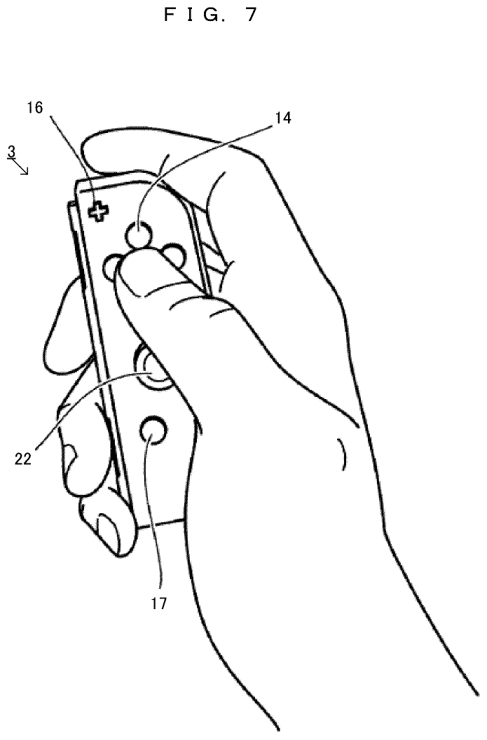

FIG. 7 is a schematic view showing an example of a state in which the user operates the right controller 3 while grasping the right controller 3 by the right hand in a longitudinal holding manner. As shown in FIG. 7, in a state in which the right controller 3 is detached from the main body apparatus 2, the right controller 3 can be used by being grasped such that the longitudinal direction of the right controller 3 is along the up-down direction or the front-rear direction for the operating user. Also in a case where the user uses, by the left hand, the left controller 4 detached from the main body apparatus 2, the left controller 4 can be used in the same manner.

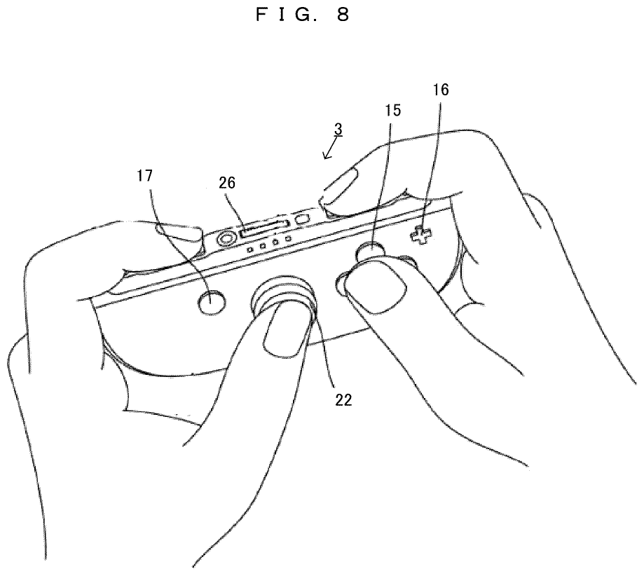

FIG. 8 is a schematic view showing an example of a state in which the user operates the right controller 3 while grasping the right controller 3 by both hands in a horizontally holding manner. As shown in FIG. 8, in a state in which the right controller 3 is detached from the main body apparatus 2, the right controller 3 is used such that the longitudinal direction of the right controller 3 is along the left-right direction for the operating user. The right controller 3 is grasped by one hand of the user on one side in the longitudinal direction (one side in the front-rear direction) and grasped by the other hand of the user on the other side. For example, the index fingers of both hands of the user are put on the bottom portion side of the right controller 3. Also in a case where the user uses, by both hands, the left controller 4 detached from the main body apparatus 2, the left controller 4 can be used in the same manner.

One user may use the right controller 3, and another user may use the left controller 4. One user may use the right controller 3 by the right hand and use the left controller 4 by the left hand, at the same time. Each of two users may use the right controller 3 and the left controller 4. That is, more than two controllers may be connected to the main body apparatus 2. For example, each of four users may use one or two controllers.

The user can perform a mouse operation of the right controller 3 in the manner (which may be referred to as “mouse operation state”) shown in FIG. 6. The user can perform, for example, an operation of the stick 22 (which may be referred to as “stick operation”) by the thumb of the right hand while grasping the right controller 3 in a longitudinal holding manner or a horizontal holding manner, and also, can perform an operation of changing the orientation of the grasped right controller 3 (which may be referred to as “orientation change operation”). The user may be allowed to perform a stick operation and an orientation change operation while using the right controller 3 in a mouse operation state. In a state in which the user is grasping the right controller 3 in a longitudinal holding manner or a horizontal holding manner, the user may perform an operation of covering the mouse sensor 44 by a finger, for example, so as to change the light reception condition of the mouse sensor 44. Also in a case where the user uses, by the left hand, the left controller 4 detached from the main body apparatus 2, the left controller 4 can be used in the same manner.

Next, information processing in the exemplary embodiment will be described. In the following description, a case of using the right controller 3 is shown as an example. A case of using the left controller 4 can be considered in the same manner and therefore will not be described except for some matters.

### Operation Mode of Controller

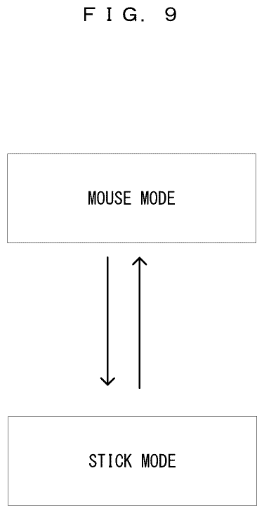

FIG. 9 illustrates operation modes of the controller and shift between the operation modes. As shown in FIG. 9, the operation modes of the controller (which may be simply referred to as “mode”) include a “mouse mode” and a “stick mode”. The mouse mode is an operation mode in which a virtual object is controlled based on an output from the mouse sensor. The stick mode is an operation mode in which a virtual object is controlled based on an output through a stick operation or an output through an inertial sensor. As an example of a virtual object, an aim sight may be displayed on a screen. For example, the mouse mode may be configured such that the aim sight is controlled based on an output from the mouse sensor and is not controlled based on a stick operation, and the stick mode may be configured such that the aim sight is not controlled based on an output from the mouse sensor and is controlled based on a stick operation. A virtual object to be controlled is not limited to the aim sight, and may be a selection frame, a pointer such as a cursor having an arrow shape, a virtual camera, or a character, for example. As the operation mode is switched, a virtual object that is an operation target may be switched, or a display manner of a virtual object that is an operation target may be switched.

### Details of Information Processing in Exemplary Embodiment

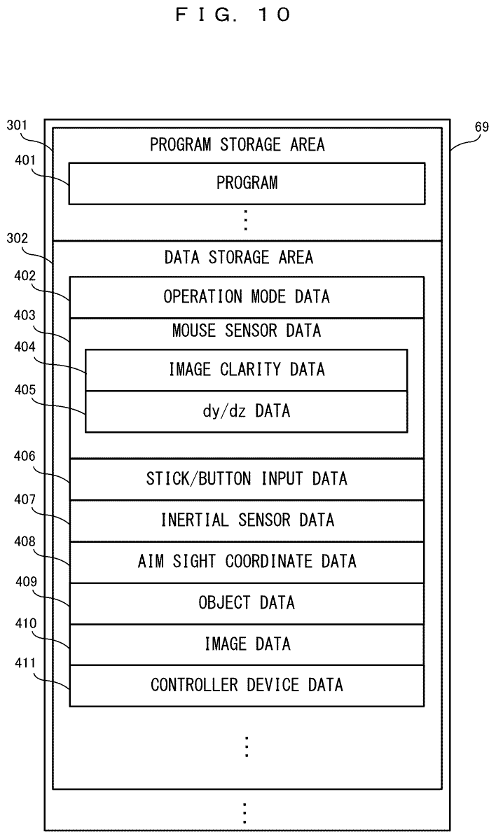

Next, with reference to FIG. 10 to FIG. 12, the information processing in the exemplary embodiment will be described in detail. In the exemplary embodiment, the operation mode can be shifted as described above. In the following description, a case of using the right controller 3 is shown as an example. A case of using the left controller 4 can be considered in the same manner and therefore will not be described.

### Used Data

Next, various data stored in the DRAM 69 will be described. FIG. 10 shows an example of data stored in the DRAM 69 of the main body apparatus 2. As shown in FIG. 10, at least a program storage area 301 and a data storage area 302 are provided in the DRAM 69.

In the program storage area 301, at least a program 401 is stored. In the data storage area 302, for example, at least operation mode data 402, mouse sensor data 403, stick/button input data 406, inertial sensor data 407, aim sight coordinate data 40l , object data 409, image data 410, and controller device data 411, are stored.

The program 401 is a program for executing processing. The program 401 is not particularly limited, and may be a game program for executing game processing, a drawing application for executing 3D model generation processing or image generation processing, or an operating program for executing an operating system, for example. In the exemplary embodiment, the program 401 is a game program for operating an aim sight.

The operation mode data 402 is data indicating which of the mouse mode and the stick mode the operation mode is, for example.

The mouse sensor data 403 is data regarding an output from the mouse sensor 24, and includes image clarity data 404 and dy/dz data 405.

The image clarity data 404 is data calculated by the mouse sensor 24 and indicating the clarity of a mouse sensor image. The image clarity data 404 is calculated based on the degree of brightness of a mouse sensor image, and/or a degree regarding how many feature points are present in the mouse sensor image, for example. The image clarity data 404 may be calculated by the communication control section 91, the processor 63, or the like, based on output data of the mouse sensor 24. The degree of brightness of the mouse sensor image or a degree regarding how many feature points are present in the mouse sensor image may be directly used as the image clarity data. The image clarity data 404 may be calculated based on another element. If the clarity indicated by the image clarity data 404 is equal to or greater than a predetermined value, it may be estimated that the opening 23 of the mouse sensor 24 is closed by a placement surface or the like. A method for estimating whether the opening 23 of the mouse sensor 24 is closed is not limited. Another data may be used for estimating whether the opening 23 of the mouse sensor 24 is closed.

The dy/dz data 405 is output data of the mouse sensor 24. In a state in which the opening 23 of the mouse sensor 24 is closed by a placement surface or the like, the dy/dz data 405 is data indicating a movement distance (which may be referred to as “dy/dz”) per frame time in the y-axis direction and the z-axis direction in the right controller coordinate system (i.e., yz plane; see FIG. 2) relative to the placement surface or the like. The dy/dz may be calculated from output data of the mouse sensor 24 by the communication control section 91, the processor 63, or the like.

The stick/button input data 406 is data indicating an operation performed on the stick 22 and each button 95 of the right controller 3.

The inertial sensor data 407 is data outputted from the inertial sensor of the right controller 3, and is data that allows calculation of accelerations in the x-, y-, and z-axis directions in the right controller coordinate system (see FIG. 2) and angular velocities around the x, y, and z axes, for example. For example, the orientation, movement, and the like of the right controller 3 can be calculated using the inertial sensor data.

The aim sight coordinate data 408 is data indicating the coordinates (which may be simply referred to as “aim sight coordinates”) of an aim sight in a screen coordinate system, for example. In the mouse mode, the aim sight coordinates move based on the dy/dz data, and in the stick mode, the aim sight coordinates move based on an operation on the stick 22.

The object data 409 is data of a virtual object placed in a virtual space, and is data of virtual objects such as an aim sight, a bullet that is shot in the direction of the aim sight, a player character, an opponent character, a ground, and a virtual camera, for example. The object data 409 may include the aim sight coordinate data 408.

The image data 410 is image data of an image of an aim sight, an animation image, a background, a virtual effect, and the like.

The controller device data 411 is data indicating devices (e.g., a mouse sensor, an acceleration sensor, an angular velocity sensor, and a stick) that the controller being connected to the main body apparatus 2 has. When the controller is connected to the main body apparatus 2 via a wire or wirelessly, data indicating devices that the controller has is transmitted from the controller to the main body apparatus 2.

Besides, various data to be used in drawing processing and the like are stored in the DRAM 69 as necessary.

### Detailed Example of Information Processing

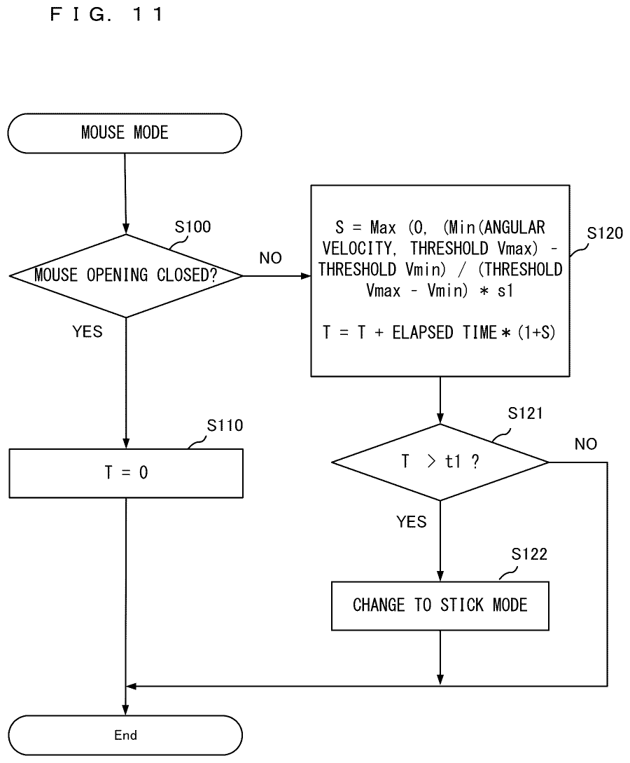

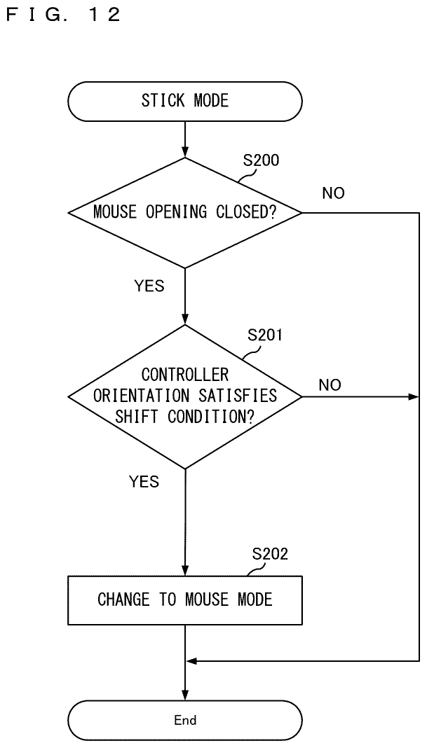

Next, processing according to the exemplary embodiment will be described with reference to flowcharts and the like. FIG. 11 and FIG. 12 are examples of flowcharts showing the processing according to the exemplary embodiment. Each step is executed by the processor 63, for example. Hereinafter, some of processes in the exemplary embodiment will be described. Each process may include another process, and in each process, certain processing may be omitted. The order of processing steps is merely an example. Some processing steps may be executed at the same time, or may be executed in a reverse order. For convenience sake, processing steps are described as divided steps, but they may be integrated processing or may be further divided. For example, the following process is executed at predetermined intervals (e.g., intervals of frame processing executed per 1/60 second).

As shown in FIG. 11, if the present operation mode is a mouse mode, whether or not the opening of the mouse sensor 24 is closed is determined (step S100). For example, it may be determined that the opening is closed, based on the fact that the image clarity data 404 indicates a predetermined value. Determination that “the opening is closed” may mean that a flag indicating the closed state of the opening, which is set based on the image clarity data 404, is referred to, or may mean a result of comparison between the image clarity data 404 and a predetermined value, for example. That is, determination that “the opening is closed” does not necessarily mean that the opening is actually closed, and may mean that a predetermined state which could be observed when the opening is closed is observed. Also in the other determinations, determination methods are not particularly limited. In the initial state, the operation mode may be either the mouse mode or the stick mode.

If it is determined that the opening of the mouse sensor 24 is not closed (step S100=NO), a timer T undergoes counting (step S120). For example, first, a scalar S is calculated based on the angular velocity of the right controller 3. If the angular velocity of the right controller 3 is equal to or smaller than Vmin, the scalar S is 0. If the angular velocity is equal to or greater than a threshold Vmax, the scalar S is s1. For example, s1 is a value greater than 0, and may be 4 or 9. If the angular velocity is a value between the threshold Vmin and the threshold Vmax, the scalar S is a value between 0 and s1 and becomes greater as the angular velocity becomes greater. In the timer T, a value obtained by multiplying a certain time by (1+scalar S) is added to the last timer T. The certain time is an elapsed time since the last routine, for example. The certain time may be a predetermined value, for example.

If the timer T is greater than a first time t1 (step S121=YES), the operation mode is changed from the mouse mode to the stick mode (step S122).

If it is determined that the opening of the mouse sensor 24 is closed in step S100 (step S100=YES), the timer T is set to 0 (step S110), so that the mouse mode is kept.

If the state in which the opening of the mouse sensor 24 is not closed is continuing, there is a possibility that the user does not intend to perform a mouse operation any longer. Changing the operation mode to the stick mode in such a case improves a user experience. On the other hand, even in a case where the user intends to continue a mouse operation, the user may lift up the controller in order to correct the position of the controller on the placement surface. Therefore, switching to the stick mode is performed when the state in which the opening of the mouse sensor 24 is not closed has continued to a certain extent, whereby the user's intention is likely to be reflected. In a case where the user intends to switch from a mouse operation to a stick operation, the user might change the orientation of the right controller 3 from the orientation shown in FIG. 6 to the orientation shown in FIG. 7, for example. Accordingly, if the right controller 3 is rotated in a state in which the opening of the mouse sensor 24 is not closed, the operation mode is switched to the stick mode earlier than when the right controller 3 is not rotated, whereby a user experience is improved.

In FIG. 11, the first time t1 is not limited, and may be 0.5 second or 1.0 second, for example. Through the processing in step S120, the timer T becomes a great value earlier when the angular velocity is greater than the threshold Vmin than when the angular velocity is equal to or smaller than the threshold Vmin. In the example shown in FIG. 11, when a state in which the angular velocity is not greater than the threshold Vmin has continued, if 0.5 second has elapsed since the opening of the mouse sensor 24 was closed, the operation mode is changed to the stick mode. In the example shown in FIG. 11, parameters may be set so that, in a case where a state in which the angular velocity is equal to or greater than the threshold Vmax has continued since the opening of the mouse sensor 24 was closed, if a time equal to or shorter than 0.5 second, for example, has elapsed, the operation mode is changed to the stick mode. For example, the operation mode may be changed to the stick mode when, in the earliest case, 0.1 second has elapsed since the opening of the mouse sensor 24 was closed.

In FIG. 11, if the angular velocity is equal to or greater than the threshold Vmax, the scalar S is fixed. Thus, for example, while the user intends to continue the mouse mode, the operation mode is inhibited from being unintentionally changed to the stick mode when the right controller 3 is rotated at high speed. The scalar S may not necessarily be fixed. When the angular velocity becomes greater than a certain value, the operation mode may be changed to the stick mode immediately.

In FIG. 11, determination in step S121 is performed based on the angular velocity, but may be performed based on an angular acceleration or another parameter related to rotation. A parameter related to the angular velocity may be an absolute value. The angular velocity may be a rotational velocity around one of three axes of the right controller 3 or three axes in an actual space, for example, or may be the average or the maximum value of angular velocities around all axes, for example. For example, the angular velocity may be a velocity around a direction connecting the front portion and the rear portion of the right controller 3, i.e., the absolute value of a velocity around the y axis. As another example, the angular velocity may be a velocity around the y axis and an angular velocity when the right controller 3 is rotated so that the stick 22 is directed toward a direction opposite to the gravity direction, from the state shown in FIG. 6. The angular velocity may be a velocity in a direction of rotation occurring when the user changes the orientation of the right controller 3 from the state shown in FIG. 6 to the state shown in FIG. 7.

FIG. 12 shows an example of a process when the operation mode is the stick mode. If the opening of the mouse sensor 24 is closed (step S200=YES) and then the orientation of the right controller 3 satisfies a shift condition (step S201=YES), the operation mode is changed from the stick mode to the mouse mode. If a result of step S200 is NO and a result of step S201 is NO, the operation mode is kept being the stick mode.

The shift condition may be a condition that the opening of the mouse sensor 24 faces in a direction including the gravity direction, for example. The shift condition may be a condition that the x-axis minus direction is in a range of ±30° with respect to the gravity direction, for example. The shift condition may be, in addition to or instead of any of the above conditions, a condition that the opening of the mouse sensor 24 faces in a direction in a range different from the above range and the orientation of the right controller 3 is such an orientation that the front portion is lower than the rear portion in a space. Thus, also in a case where the user performs a mouse operation of the right controller 3 on a curved surface of the thigh or the like, for example, it is possible to change the operation mode in accordance with the user's intention.

### Other Examples of Information Processing

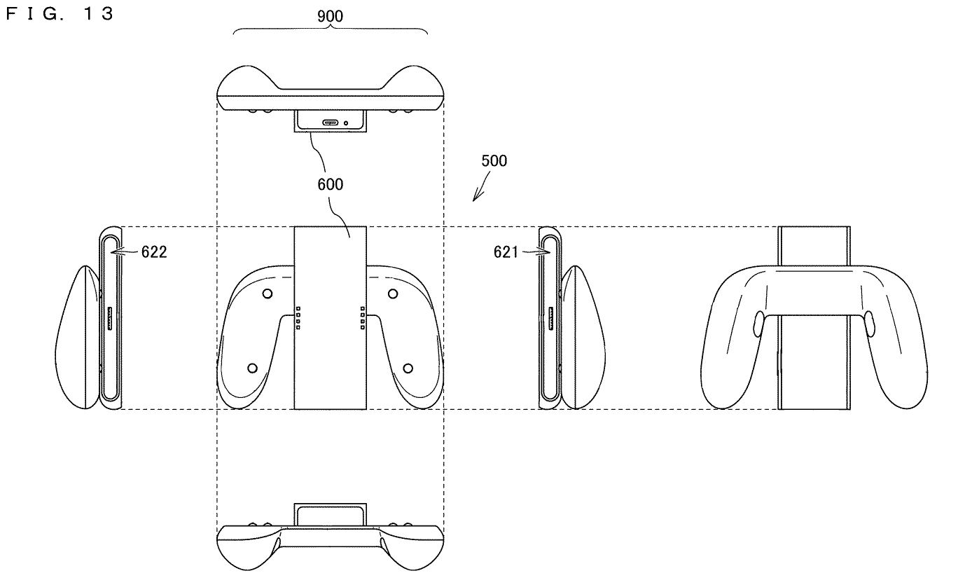

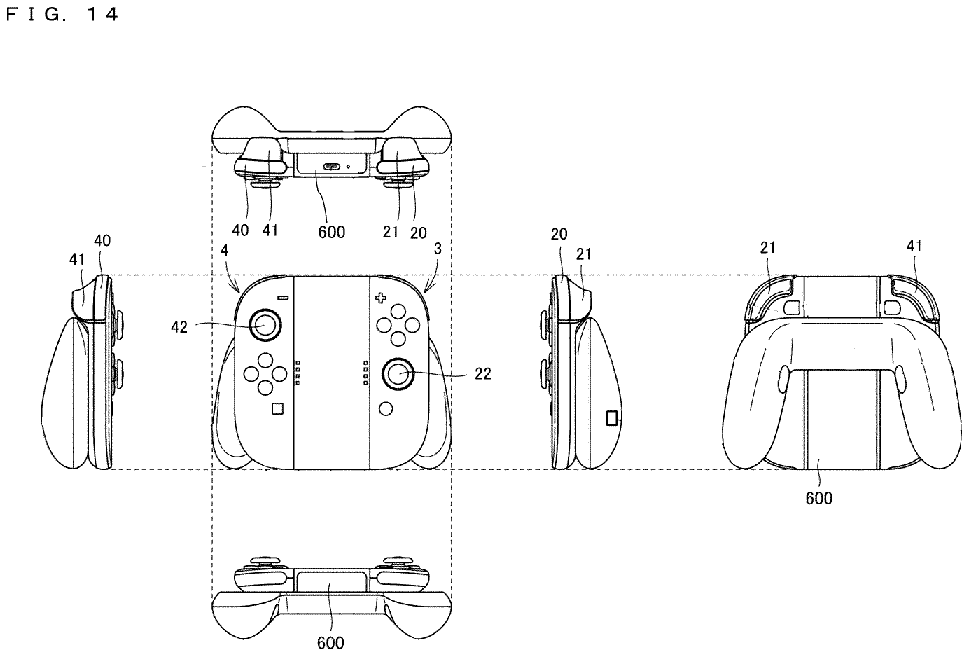

The right controller 3 and/or the left controller 4 may be configured to be attached to a peripheral device. The peripheral device may be configured to cover the opening of the mouse sensor when a controller is attached. The shape, usage, and number of controllers that can be attached to the peripheral device are not limited. A mounting mechanism for attaching a controller to the peripheral device is not limited. FIG. 13 shows an example of a peripheral device. As shown in FIG. 14, in the peripheral device 500 according to the present embodiment, the above-described right controller 3 and left controller 4 are detachably attached.

As shown in FIG. 13, the peripheral device 500 comprises a support portion 600 and a grip module 900 that is attached to a rear surface of the support portion 600. The support portion 600 supports a game controller. The grip module 900 is configured to be gripped by both hands of a user.

The support portion 600 comprises a first recess 621 and a second recess 622. The first recess 621 is located on the right side surface of the support portion. The second recess 622 is located on the left side surface of the support portion. In the first recess 621, the protruding portion 25 of the right controller 3 fits. In the second recess 622, the protruding portion 45 of the left controller 4 fits.

When a controller is used while being attached to the peripheral device 500, it is assumed that a user intends to use the controller in the above-described stick mode. However, when a controller is attached to the peripheral device 500, as shown in FIG. 14, the opening of the mouse sensor is covered. Therefore, as described above, in a case where switching of the mouse mode is determined based on whether the opening of the mouse sensor is covered, the controller attached to the peripheral device 500 will continue to be determined to be in the mouse mode. Accordingly, as another example of information processing, control may be performed such that, although the opening of the mouse sensor is covered, if input as a mouse is small and movement of the controller itself occurs, switching from the mouse mode to the stick mode is performed. Movement of the controller itself refers to, for example, when a change in posture of the controller occurs or when acceleration in a translational direction occurs.

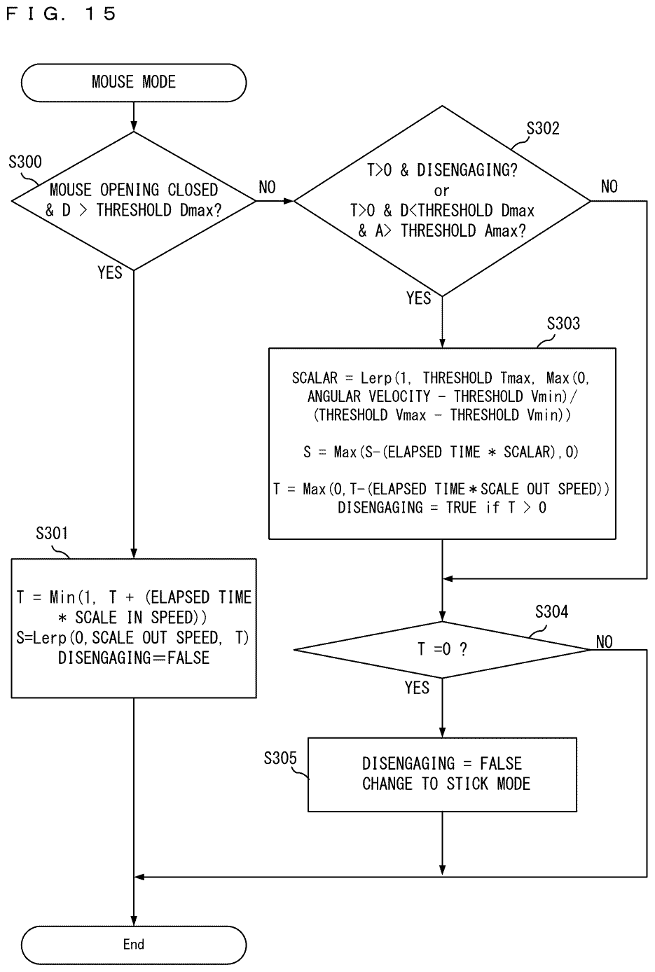

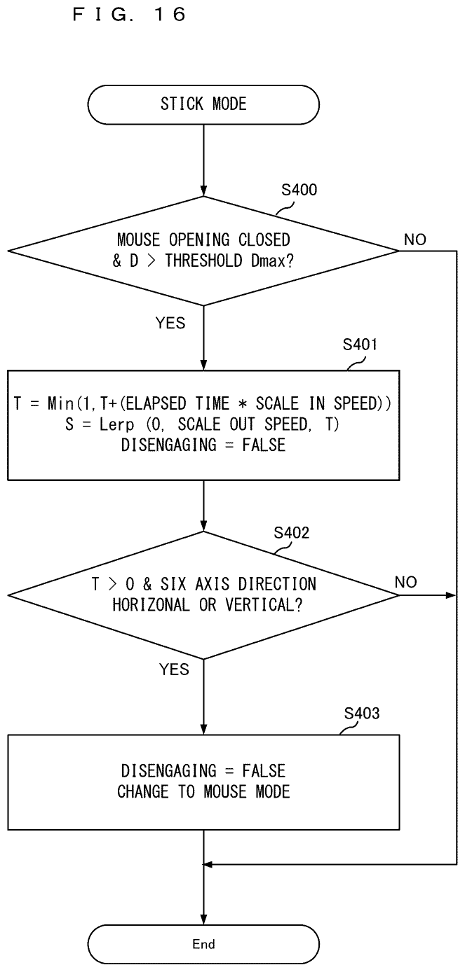

FIGS. 15 and 16 show other examples of information processing in a case where the peripheral device is used. The following example of information processing is also, similarly to the above, merely an example, and, for instance, the order of processing and values to be set are not limited.

As shown in FIG. 15, when the current operation mode is the mouse mode, it is determined whether the opening of the mouse sensor 24 is covered and whether a movement amount D is greater than a threshold value Dmax (step S300). The movement amount D is a variable indicating a movement amount of a mouse, and is calculated based on, for example, the above-described dy/dz data 405. The movement amount D may be dy or may be dz.

When the opening of the mouse sensor 24 is covered and it is determined that the movement amount D is greater than the threshold value Dmax (step S300=YES), scaling processing in a direction to maintain the mouse mode is executed (step S301). Specifically, first, a timer T is calculated. The timer T is obtained by setting 1 as a maximum value and adding to the previous value a product of elapsed time and a constant Scale in speed. Further, a scale S is calculated. The scale S is a value linearly interpolated by the timer T between 0 and a constant Scale out speed. As understood from step S303, the larger the value of scale S, the more difficult it becomes to transition from the mouse mode to the stick mode. As another process, the larger the value of scale S, the greater the amount by which objects such as a mouse cursor are moved in response to output from the mouse sensor may be. That is, the scale S may have a role of determining ease of transition to the stick mode, in addition to a role of determining ease of movement of the mouse cursor. Further, a value FALSE is set to a variable DISENGAGING. The variable DISENGAGING is a flag indicating whether the controller is attempting to separate from a placement surface.

In step S300, when it is determined that the opening of the mouse sensor 24 is not covered, or is covered but the movement amount D is not greater than the threshold value Dmax (step S100=NO), the following conditions are determined. That is, (1) whether the timer T is greater than 0 and the variable DISENGAGING is True, or (2) whether the timer T is greater than 0, the movement amount D is less than the threshold value Dmax, and an acceleration parameter A is greater than a threshold value Amax, is determined (step S302). Here, condition (1) is a condition for continuing determination in step S302 until the timer T becomes 0 after processing in step S303 described later is started. Also, condition (2) is for determining that, even though the opening of the mouse sensor 24 is covered and the movement amount of the mouse is small, the acceleration of the controller exceeds the threshold value. In other words, it is for determining that there is a possibility that the controller is mounted on the above-described peripheral device 500. The acceleration parameter of the controller is an example of a parameter based on an inertial sensor indicating movement of the controller. The parameter indicating movement of the controller is not limited, and may be, for example, velocity, angular velocity, or angular acceleration.

In step S302, when it is determined that the above conditions are not satisfied (step S302=NO), processing proceeds to step S304 described later.

In step S302, when it is determined that the above conditions are satisfied (step S302=YES), scaling processing in a direction to terminate the mouse mode is performed (step S303). First, a variable SCALAR is calculated. The variable SCALAR is an interpolated value according to angular velocity. The greater the angular velocity, the greater the variable SCALAR becomes. Also, the greater the angular velocity, the faster the timer T becomes 0. That is, the greater the angular velocity, the faster transition to the stick mode becomes possible. Further, a scale S is calculated. The scale S is obtained by subtracting a product of elapsed time and the variable SCALAR from the previous value of scale S, with 0 as a minimum value. Further, a timer T is calculated. The timer T is obtained by subtracting a product of elapsed time, scale S, and a constant Scale out speed from the previous value of timer T, with 0 as a minimum value. Then, when the calculated timer T is greater than 0, the variable DISENGAGING is set to True.

Next, it is determined whether the timer T is 0 (step S304). When the timer T is determined to be 0 (step S304=YES), the variable DISENGAGING is set to FALSE. Then, the operation mode is switched to the stick mode (step S305).

In step S304, when the timer T is determined not to be 0 (step S304=NO), the mouse mode is maintained.

FIG. 16 shows an example of processing when the operation mode is the stick mode. When the opening of the mouse sensor 24 is covered and the movement amount D is greater than the threshold value Dmax (step S400=YES), the timer T and the scale S are calculated by processing similar to step S301 in the above-described mouse mode processing. Further, the variable disengaging is set to false (Step S401).

Next, it is determined whether the timer T is greater than 0 and whether the orientation of the controller is horizontal or vertical (step S402). The orientation of the controller is determined using six-axis directional parameters based on output from the inertial sensor. In the present embodiment, it is determined whether it is within an angle range in which the mouse sensor faces the direction of gravity (horizontal state), or within an angle range in which the mouse sensor 24 faces a direction perpendicular to the direction of gravity and the R button 20 and ZR button 21 face the direction of gravity (vertical state). It should be noted that “horizontal state” does not mean strictly horizontal, and includes a state deviated to some extent from strict horizontality, in which mouse operation is presumed to be performed. “Vertical state” is similar. Since the controller of the present embodiment may be operated as a mouse on the thigh of a standing user, the vertical state is also determined. The types, number, and range of angles to be determined are merely examples and are not limited. Through this determination, the likelihood that the controller is being used as a mouse can be inferred.

In step S402, when it is determined as YES (step S402=YES), the variable DISENGAGING is set to FALSE. Then, the operation mode is switched to the mouse mode (step S403).

In step S402, when it is determined as NO (step S402=NO), the stick mode is maintained.

Also, in step S400, when it is determined as NO (step S400=NO), the stick mode is maintained.

### Modifications

The processes shown in FIG. 11 and FIG. 12 described above are merely an example. Instead of or in addition to the above processes, the following processes may be executed, for example.

In the process shown in FIG. 11, instead of or in addition to the angular velocity, the orientation of the right controller 3 may be used. For example, in a case where the orientation of the right controller 3 is an orientation in which the stick 22 is approximately directed in a direction opposite to the gravity direction, the operation mode may be changed to the stick mode in a shorter closing continuation time.

In the process shown in FIG. 11 or FIG. 12, for example, an output from the acceleration sensor 96 or an output based on an operation on the stick 22 or the buttons 12 to 21 may be used.

A method for shortening the required time in changing from the mouse mode to the stick mode based on the angular velocity of the right controller 3 is not limited. For example, instead of the process shown in FIG. 11, control may be performed such that, in a state in which the mouse sensor opening 24 is closed, if the angular velocity is smaller than a first velocity, the closing continuation time is compared with a second time t2, and if the angular velocity is equal to or greater than the first velocity, the closing continuation time is compared with a third time t3 shorter than the second time t2.

The operation modes are not limited to the mouse mode and the stick mode. The operation modes may include a gyro operation mode in which a virtual object is controlled based on an output from an inertial sensor, for example, or may include another operation mode. A condition for changing the operation mode from the mouse mode to the gyro mode, for example, is not limited. In a case where the operation modes include the gyro mode instead of the stick mode, for example, in the process shown in FIG. 11, the operation mode may be changed to the gyro mode instead of the stick mode. In a case where the operation modes include the gyro mode instead of or in addition to the stick mode, for example, in the process shown in FIG. 11, when a predetermined button of the right controller 3 or the left controller 4 is being pressed, the operation mode may be changed to the gyro mode instead of the stick mode. Changing from the mouse mode to the gyro mode may always require a constant time irrespective of the state of the right controller 3. The operation mode may be directly changed between the stick mode and the gyro mode, based on a predetermined condition. In the stick mode, when a predetermined operation is performed, or at all times, a virtual object subjected to operation based on a stick operation may be operated based on an output from the inertial sensor. At this time, the stick mode may be considered the same as the gyro mode, in the processes shown in FIG. 11 and FIG. 12.

The display manner of the virtual object to be operated may be changed in accordance with the operation mode. Also in this case, the virtual object can be considered substantially the same aim sight.

When the operation mode is switched, the position of the virtual object may be switched. For example, while the aim sight is operated in the mouse mode, if the operation mode is changed to the stick mode, the aim sight may be placed at the last aim sight position set when the aim sight was previously operated in the stick mode.

The virtual object to be operated may be switched in accordance with the operation mode. For example, in the mouse mode, the aim sight may be operated in accordance with a mouse operation and a character may be operated in accordance with an operation on the stick 22, and in the stick mode, the virtual object may not be operated in accordance with a mouse operation and the virtual camera may be operated in accordance with a stick operation.

In accordance with switching of the operation mode based on the state of the right controller 3, processing to be executed through an operation on the left controller 4 may be changed. For example, a virtual object to be controlled through an operation on the stick 42 of the left controller 4 may differ between the mouse mode and the stick mode switched based on the state of the right controller 3.

Switching of the operation mode may be performed based on not only the state of one controller but also the states of both controllers.

Also, regarding processing in a case where a peripheral device is used, it may be possible to allow operation in different manners between a stick mode in a state where a controller is attached to the peripheral device (first stick mode) and a stick mode in a state where the controller is not attached to the peripheral device (second stick mode). For example, when operating a virtual object, in the first stick mode, operation may be enabled by stick operation, and in the second stick mode, operation based on output from an inertial sensor may be enabled. Also for example, a behavior of a virtual object when a stick is input in a first direction in the first stick mode and a behavior of a virtual object when a stick is input in a second direction perpendicular to the first direction in the second stick mode may be made the same.

In the exemplary embodiment described above, the case where determination and setting for modes are performed by the game program executed in the main body apparatus, has been shown. However, determination and setting for modes may be performed by another program (e.g., an operating program) executed in the main body apparatus, and game processing may be performed by the game program executed in the main body apparatus, based on the determination and the setting. A process for determination and setting for modes and various processes implementing the game processing may be shared between the operating program and the game program. The controller may perform determination and setting for modes.

Various data in the exemplary embodiment described above are merely an example. In another processing, another data converted from the above data, or the like, may be used as appropriate.

The game system is an example of an information processing system. The main body apparatus in the game system may be a general-purpose personal computer in which the game is executed, for example. The information processing system may be a system in which the game is not executed. Also, the controller is merely an example, and the shape or the like of the controller is not limited. The controller may not necessarily be attachable and detachable to and from the main body apparatus. The controller may not necessarily be one set of two controllers as in the exemplary embodiment, and may be a controller that is basically used alone at all times.

In an information processing system including a terminal-side device and a server-side device that can communicate with each other via a network, the server-side device may execute at least a part of the series of processes described above. The server may be composed of a plurality of information processing apparatuses, and processes may be executed by the plurality of information processing apparatuses in a shared manner.

While the exemplary embodiments and modifications have been described above, it is to be understood that the above description is, in all aspects, merely an illustrative example, and is not intended to limit the scope thereof. In addition, it is to be understood that various improvements and changes can be made on the exemplary embodiments and modifications.

What is claimed is:

1. One or more non-transitory computer-readable media storing a program that causes a computer to execute information processing when executed by one or more processors, wherein the information processing comprises:
in a first mode, operating a first virtual object based on output from a first mouse sensor of a first controller configured to be detachably attached to a peripheral device that covers an opening to the first mouse sensor;
in a second mode, operating the first virtual object or a second virtual object based on output from a first sensor of the first controller, without operating the first virtual object based on output from the first mouse sensor;
changing from the second mode to the first mode based at least on the opening to the first mouse sensor of the first controller being covered; and
changing from the first mode to the second mode based at least on the opening to the first mouse sensor being covered, movement in two-dimensional directions indicated by the first mouse sensor being smaller than a first value, and movement of the first controller indicated by a first inertial sensor of the first controller being greater than a second value.

2. The one or more non-transitory computer-readable media according to claim 1, wherein the information processing comprises:
changing from the first mode to the second mode based at least on the opening to the first mouse sensor not being covered.

3. The one or more non-transitory computer-readable media according to claim 1, wherein the information processing comprises:
in a third mode, operating the first virtual object or the second virtual object in a manner different from the second mode, based on output from the first sensor, without operating the first virtual object based on output from the first mouse sensor; and
changing from the first mode to the third mode based at least on the opening to the first mouse sensor not being covered.

4. The one or more non-transitory computer-readable media according to claim 1, wherein the information processing comprises:
changing from the first mode to the second mode based at least on:
the opening to the first mouse sensor being covered,
movement in two-dimensional directions indicated by the first mouse sensor being smaller than a first value,
movement of the first controller indicated by a first inertial sensor being greater than a second value,
the opening to a second mouse sensor of a second controller configured to be detachably attached to the peripheral device being covered,
movement in two-dimensional directions indicated by the second mouse sensor being smaller than a third value,
and movement of the second controller indicated by a second inertial sensor of the second game controller being greater than a fourth value.

5. The one or more non-transitory computer-readable media according to claim 1, wherein the first sensor is at least one of: the first inertial sensor, or a sensor configured to detect operation on a first directional input unit of the controller.

6. An information processing system comprising:
one or more processors;
a first controller comprising a first mouse sensor and a first inertial sensor; and
a peripheral device to which the first controller is detachably attached so as to cover an opening to the first mouse sensor;
one or more non-transitory recording media that cause a computer to execute information processing when executed by the one or more processors,
wherein the information processing comprises:
in a first mode, operating a first virtual object based on output from the first mouse sensor;
in a second mode, operating the first virtual object or a second virtual object based on output from at least one of the first inertial sensor or a first sensor further provided in the first controller, without operating the first virtual object based on output from the first mouse sensor;
changing from the second mode to the first mode based at least on the opening to the first mouse sensor being covered; and
changing from the first mode to the second mode based at least on the opening to the first mouse sensor being covered, movement in two-dimensional directions indicated by the first mouse sensor being smaller than a first value, and movement of the first controller indicated by the first inertial sensor being greater than a second value.

7. The information processing system according to claim 6, wherein changing from the first mode to the second mode based at least on the opening to the first mouse sensor not being covered.

8. The information processing system according to claim 6, wherein
in a third mode, operating the first virtual object or the second virtual object in a manner different from the second mode, based on output from the first sensor, without operating the first virtual object based on output from the first mouse sensor; and
changing from the first mode to the third mode based at least on the opening to the first mouse sensor not being covered.

9. The information processing system according to claim 6, wherein
the information processing system further comprising a second controller comprising a second mouse sensor and a second inertial sensor;
the peripheral device configured such that the first controller is detachably attached so as to cover an opening to the first mouse sensor, and the second sensor is detachably attached so as to cover an opening to the second mouse sensor; and
the information processing comprises;
changing from the first mode to the second mode based at least on:
the opening to the first mouse sensor being covered,
movement in two-dimensional directions indicated by the first mouse sensor being smaller than a first value,
movement of the first controller indicated by a first inertial sensor being greater than a second value,
the opening to a second mouse sensor of a second controller configured to be detachably attached to the peripheral device being covered,
movement in two-dimensional directions indicated by the second mouse sensor being smaller than a third value,
and movement of the second controller indicated by a second inertial sensor of the second game controller being greater than a fourth value.

10. A computer-implemented method comprising:
in a first mode, operating a first virtual object based on output from a first mouse sensor of a first controller configured to be detachably attached to a peripheral device that covers an opening to the first mouse sensor;
in a second mode, operating the first virtual object or a second virtual object based on output from a first sensor of the first controller, without operating the first virtual object based on output from the first mouse sensor;
changing from the second mode to the first mode based at least on the opening to the first mouse sensor being covered;
and changing from the first mode to the second mode based at least on the opening to the first mouse sensor being covered, movement in two-dimensional directions indicated by the first mouse sensor being smaller than a first value, and movement of the first controller indicated by a first inertial sensor provided in the first controller being greater than a second value.

11. The computer-implemented method according to claim 10, wherein changing from the first mode to the second mode based at least on the opening to the first mouse sensor not being covered.

12. The computer-implemented method according to claim 10, wherein in a third mode, operating the first virtual object or the second virtual object in a manner different from the second mode, based on output from the first sensor, without operating the first virtual object based on output from the first mouse sensor; and
changing from the first mode to the third mode based at least on the opening to the first mouse sensor not being covered.

13. The computer-implemented method according to claim 10, wherein
changing from the first mode to the second mode based at least on:
the opening to the first mouse sensor being covered,
movement in two-dimensional directions indicated by the first mouse sensor being smaller than a first value,
movement of the first controller indicated by a first inertial sensor being greater than a second value,
the opening to a second mouse sensor of a second controller configured to be detachably attached to the peripheral device being covered,
movement in two-dimensional directions indicated by the second mouse sensor being smaller than a third value,
and movement of the second controller indicated by a second inertial sensor of the second game controller being greater than a fourth value.
